(19) United States
(12) Patent Application Publication
(10) Pub. No.: US 2014/0266149 A1
(43) Pub. Date: Sep. 18, 2014

(54) COVER-TESTING FIXTURE FOR RADIO FREQUENCY SENSITIVE DEVICES

(71) Applicant: MOTOROLA MOBILITY LLC, Libertyville, IL (US)

(72) Inventors: Juan M. Martinez, Antioch, IL (US); Francis C. Cheo, Vernon Hills, IL (US); Peruvemba Ranganathan Sai Ananthanarayanan, Naperville, IL (US)

(73) Assignee: MOTOROLA MOBILITY LLC, Libertyville, IL (US)

(21) Appl. No.: 14/095,261

(22) Filed: Dec. 3, 2013

Related U.S. Application Data
(60) Provisional application No. 61/776,810, filed on Mar. 12, 2013.
(60) Provisional application No. 61/781,251, filed on Mar. 14, 2013.

(51) Int. Cl. G01N 27/00

(52) U.S. Cl. CPC G01N 27/00
USPC 324/71.1

(57) ABSTRACT

A method for determining variations in the metallic content of a cover of a mobile communications device at different locations simultaneously includes configuring a radio frequency signal generator to generate a standing wave along a transmission line including a first conductor formed from a thin conductive film on a first side of a first nonconductive substrate and transmitting a signal on a frequency corresponding to the standing wave to excite a plurality of magnetic and electric field peaks along the first conductor coinciding with the positioning of the cover at different locations wherein the transmission line also includes a second conductor formed from a thin metallic film substantially covering a first side of a second nonconductive substrate positioned parallel to the first nonconductive substrate whereby the second conductor is electromagnetically coupled to the first conductor to identify detectable deviations in the scattering parameters (S-11) or return loss response of the transmission line.

### TECHNICAL FIELD

The disclosure relates to a test fixture, apparatus and method for testing a device cover, in particular a metalized cover for the presence of metal in an amount sufficient to adversely affect the function of antennae embedded in the cover.

### BACKGROUND

Mobile communication devices, in particular, cellular phones typically use a plurality of antennas for reception and transmission of radio frequency signals. The antennas are often narrow band antennas positioned in locations around the edges of the mobile communication device. In order to avoid electromagnetic interference with the antennas, covers or trim adjacent to such antennae may be fabricated from non-conductive materials such as plastics that are substantially RF transparent. However, in the case of cellular phones a metallic surface finish or metallic look is often desirable. In order to obtain the desired finish, covers and/or trim members may be coated with a non-conductive vacuum metalized finish that provides the desired metallic look and feel. Although substantially non-conductive, these finishes do include an amount of metal which, due to manufacturing variances, may vary within the coating material and coating layer. Thus, localized areas of a cover may include excessive metal that affects the performance of RF antennas proximate the coating. Further, since the antennas may be tuned in the presence of metallic parts, at one extreme a cover or part behaving like a pure plastic may be considered a defect while, at another extreme, a part with excessive metal loading a cover or part may also be considered defective.

Different methods have been employed in the past to test parts such as cellular phone covers for one or more areas having sufficient metallic content that may interfere with antennas located adjacent or near the cover. However, the means available for such testing the covers for metallic content do not always have the required sensitivity to detect metallic content sufficient to cause interference. Further the currently available testing means is limited to testing only a small, discrete area of the cover and is incapable of testing the entire cover at once. This is problematic in the case of covers for cellular phones which, when installed had the potential to interfere with the operation of multiple antennae located proximate to and inside the cover.

### BRIEF DESCRIPTION OF THE DRAWINGS

For a more complete understanding, reference is now made to the following description taken in conjunction with the accompanying drawings in which:

FIG. 1 illustrates a cover for a radio frequency sensitive device such as a cellular phone;

FIG. 2 is a side-section view of a test apparatus for testing the cover of FIG. 1 for metallic content;

FIG. 3 illustrates the cover of FIG. 1 positioned on the test apparatus of FIG. 2;

FIG. 4 is a top view of a bottom plate of the test apparatus of FIG. 2;

FIG. 5 is bottom view of a top plate of the test apparatus of FIG. 2;

FIG. 6 is a schematic model of the test apparatus of FIG. 2;

FIG. 7 illustrates a magnetic field model of the test apparatus of FIG. 2;

FIG. 8 illustrates a electric field model of the test apparatus of FIG. 2;

FIG. 9 is a schematic illustrating the electric field distribution of the cover of FIG. 1 under test in the test apparatus of FIG. 2;

FIG. 10 is a schematic illustrating a test system utilizing the test apparatus of FIG. 2;

FIGS. 11 and 12 are graphical test results for parts tested using test apparatus of FIG. 2; and

FIG. 13 is a block diagram illustrating one method of testing a part with the test apparatus of FIG. 2.

### DETAILED DESCRIPTION

Embodiments include an apparatus for determining variations in the metallic content of a cover of a mobile communications device at a plurality of different locations corresponding to multiple antenna positions adjacent the cover. The apparatus includes a radio frequency signal generator for generating a standing wave along a transmission line. The transmission line includes a first conductor strip and a first planar nonconductive substrate having a first side. The first conductor strip is formed from a thin conductive film on, about and proximate to the perimeter of the first side of the first planar nonconductive substrate. The first conductor strip may be positioned to extend proximate to the periphery of the cover. The first conductor strip is connected at a first end to the radio frequency signal generator and is configured to transmit a signal on a frequency corresponding to the standing wave. The signal excites a plurality of magnetic and electric (or electromagnetic) field peaks extending along the first conductor strip that coincide with a predetermined positioning of the cover at the plurality of different locations corresponding to the multiple antenna positions adjacent the cover.

The transmission line includes a second planar conductor formed from a thin metallic film substantially covering a first side of a second nonconductive planar substrate, the second nonconductive planar substrate and the second planar conductor being substantially parallel to the first conductor strip, the second conductor being electromagnetically coupled to the first conductor strip.

The plurality of magnetic and electric field peaks, excited by the signal, are additionally configured to electromagnetically couple potential metallic content of the cover to the first conductor strip. Variations in metallic content of the cover at one or more different locations of the cover, proximate to the multiple antenna positions adjacent to the cover, create detectable deviations in the scattering parameters response of the transmission line. In this manner, a plurality of different locations of the cover is simultaneously tested for variations in the metallic content.

In one aspect, the mobile communications device is a cellular phone and the potential metal content of the cover is in a coating that is a non-conductive vacuum metalized finish applied to an exterior surface of the cover. The number of the plurality of magnetic field and electric peaks corresponding to the plurality of different locations may be varied to correspond with at least one different location by adjusting the frequency of the radio frequency signal generator whereby the at least one different location is simultaneously tested for variations in metallic content. In another aspect, the magnetic and electric peaks couple or decouple with the cover's structure to detect physical nonconformities of a shape of the cover such as whether the cover is warped from its expected shape.

In another aspect the apparatus includes at least one nonconductive guide member attached to the first planar nonconductive substrate. The nonconductive guide member is configured to retain the cover adjacent the second side of the first planar nonconductive substrate such that the cover is electromagnetically coupled to the first conductor strip when the first conductor strip is excited with the radio frequency signal source. The first and second planar nonconductive substrates may also be interconnected with multiple spaced apart nonconductive connectors that maintain a predetermined distance between the first and second substrates.

In another variation, a system is provided for determining variations in the metallic content of a cover of a mobile communications device at a plurality of different locations corresponding to multiple antenna positions adjacent to the cover. The system includes a test apparatus having a transmission line including a first conductor. The test apparatus has a first planar nonconductive substrate having a first side with the first conductor strip being formed from a thin conductive film on, about and proximate to the perimeter of the first side of the first planar nonconductive substrate. The first conductor strip is connected at a first end to the radio frequency signal generator and is configured to transmit a signal on a frequency corresponding to the standing wave. The signal excites a plurality of magnetic and electric field peaks extending along the first conductor strip and coincides with a predetermined positioning of the cover at the plurality of different locations corresponding to the multiple antenna positions adjacent the cover.

The transmission line includes a second planar conductor formed from a thin metallic film substantially covering a first side of a second nonconductive planar substrate. The second nonconductive planar substrate and the second planar conductor being substantially parallel to the first conductor strip with the second conductor being electromagnetically coupled to the first conductor strip. The test apparatus further includes at least one nonconductive guide member attached to the first planar nonconductive substrate. The nonconductive guide is configured to retain the cover adjacent the second side of the first planar nonconductive substrate such that the cover is electromagnetically coupled to the first conductor strip when the first conductor strip is excited with the radio frequency signal source.

The system also includes a radio frequency signal generator coupled to the first conductor for generating a standing wave along the transmission line. A display is provided to show the scattering parameters response of the transmission line. In one embodiment, the radio frequency generator may be a component of a network analyzer. The display may be housed in the network analyzer with the signal generator. In operation, the plurality of magnetic field peaks, excited by the signal, electromagnetically couple potential metallic content of the cover to the first conductor strip. Variations in the metallic content of the cover at one or more different locations of the cover, proximate to the multiple antenna positions adjacent to the cover, may then be detected as deviations in the scattering parameters response of the transmission line.

In yet another aspect, a method is provided for determining variations in the metallic content of a cover of a mobile communications device at a plurality of different locations corresponding to multiple antenna positions adjacent the cover. The method includes configuring a radio frequency signal generator to generate a standing wave along a transmission line. The transmission line may include a narrow, first conductor strip formed from a thin conductive film positioned around and adjacent to the perimeter of a first side of a first planar nonconductive substrate. A second planar conductor that is also part of the transmission line is formed from a thin metallic film substantially covering a first side of a second nonconductive planar substrate. The second nonconductive planar substrate and the second planar conductor are substantially parallel to the first conductor strip, with the second conductor being electromagnetically coupled to the first conductor strip.

The method further includes the step of transmitting, with the signal generator, a signal on a frequency corresponding to the standing wave whereby the signal excites a plurality of magnetic and electric field peaks along the first conductor strip coinciding with a predetermined positioning of the cover at the plurality of different locations that correspond to the multiple antenna positions. The plurality of magnetic field peaks, excited by the signal, electromagnetically couple potential metallic content of the cover to the first conductor strip such that variations in metallic content of the cover at one or more different locations of the cover, proximate to the multiple antenna positions adjacent to the cover, create detectable deviations in the scattering parameters (S-11) response of the transmission line. The detectable deviations in the scattering parameters (S-11) response of the transmission line may be identified as an indication of the metallic content of the cover at the one or more different locations on the cover.

Referring now to the drawings, wherein like reference numbers are used herein to designate like elements throughout, the various views and embodiments of a cover-testing fixture for radio frequency sensitive devices are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

FIG. 1 is a top view of a trim cover 100 for a mobile cellular phone. Cover 100 may include a plurality of openings 102 where different components of the cell phone, for example switches, connectors and a display are fitted. Cover 100 includes an exterior coating comprising a non-conductive vacuum metalized finish 103 that covers all or selected portions of the cover. Cover 100 may also be positioned over or adjacent to multiple embedded antennas, including narrow band antennas positioned at different locations in the cell phone. To avoid interference with the operation of these antennas, areas 104 of the cover must be substantially RF transparent. To insure that these areas meet the required level of RF transparency, the areas need to be tested for RF conductivity.

FIG. 2 is side sectional view of a test apparatus 200 for testing a trim cover including multiple areas 104 that may be positioned adjacent to embedded antennas in a mobile communications device such as a cell phone. Test apparatus 200 includes an upper plate 202, a lower plate 204 and a plurality of spacers 206 that separate the plates, maintaining a predetermined substantially parallel spacing between the plates. Apparatus 200 may be provided with transversely extending guides 210 for holding a test piece such as cover 100 in position as the part is being tested. Spacers 206 and guides 210 are formed from a suitable non-conductive material such as nylon. As illustrated, plates 202, 204, spacers 206 and guides 210 may be secured together with screws 208 formed from nylon or other suitable material. FIG. 3 illustrates cover 100 positioned for testing on apparatus 200 with guides 210 extending through an opening 102 of the cover.

FIG. 4 is a top view of the lower or bottom plate 204 of apparatus 200. Referring to FIGS. 2 and 4, in one embodiment, bottom plate 204 includes a non-conductive substrate 212 with a first, wide conductor 214 formed on the top surface of the board. In one embodiment, bottom plate 204 is a singled sided copper clad board having a flame resistant grade 4 (FR4) substrate 212 with a first, wide copper conductor 214 formed on the top surface of the board. As illustrated, wide copper conductor 214 covers substantially all of the area of the top surface of substrate 212. In one embodiment, bottom plate 204 has a width of approximately 71 mm, a length of approximately 132 mm and a thickness of approximately 1.6 mm. A plurality of screw holes 215 are formed though bottom plate 204 to receive screws 208.

FIG. 5 is a bottom view of the upper or top plate 202. Referring to FIGS. 2 and 5, top plate 202 includes a non-conductive substrate 216 with a second, linear, narrow conductor strip 218 formed around the perimeter of plate 202. Upper plate 202 may be a flame resistant grade 4 (FR4) substrate 216 with second narrow copper conductor 218 printed around the perimeter of the bottom surface of the board. In one embodiment, narrow conductor 218 has a width of approximately 1 mm and is printed in sections approximately 130 mm× and 69 mm and 130 mm×65 mm around the perimeter of substrate 216. As illustrated, conductor strip 218 extends substantially parallel to the surface and/or edges of wide conductor 214 along the lengths thereof. Top plate 202 includes a plurality of screw holes 215 provided to receive nonconductive screws 208 that secure top plate 202, bottom plate 204 and spacers 206 in position. In one embodiment, spacers 206 maintain a gap of approximately 9 mm between wide conductor 214 and narrow conductor 218.

A transmission line is formed between wide conductor 214 and narrow conductor 218 when fed with a coax cable 225 having its outer conductor 220 soldered to wide conductor 214 and the center conductor 221 soldered to narrow conductor 218. As illustrated, coax cable 225 passes through an aperture 222 formed in bottom plate 204 with the center conductor 221 of the coax cable soldered to an end 223 of the narrow conductor 218. An RF signal source 228 is connected to cable 225 with a coax connector 224.

FIG. 6 is a schematic illustrating the principle of operation of test apparatus 200. Apparatus 200 detects variations of the physical or electrical properties of a part such as cover 100 as variations in the characteristic impedance of a transmission line. Apparatus 200 may be understood as a succession of lumped inductors 230 in series and a succession of lumped capacitors 232 in parallel. Lumped inductors 230 equate to a given length of the conductors forming the transmission line and lumped capacitors 232 equate to the capacitance between the conductors along the same given length of the transmission line. The peaks of standing waves induced with a vector network analyzer or similar signal source are used as sensors of variations in the electrical properties of the test piece.

FIG. 7 is a schematic representation illustrating a magnetic model of apparatus 200. The transmission line 240 (i.e., the transmission line formed between wide conductor 214 and narrow conductor 218) of apparatus 200 is shown with the location of the induced magnetic peaks represented by dotted lines 242. FIG. 7 schematically illustrates line inductance 244 and line capacitance 246 along with stray capacitance 248 and inductance 250 induced by the presence of metal in a test piece such as cover 100. At each magnetic field peak 242 of a standing wave created by the RF signal source 228 high currents are induced. At the locations 242 of the magnetic field peaks, a piece or concentration of metal in a test piece, such as cover 100, can be located when in close proximity to narrow conductor 218. The piece or concentration of metal will act as a magnetic transformer with the magnetic coupling between a primary and a secondary determined by the distance between the piece or concentration of metal and the conductor. The induced magnetic field excites a current in the metallic piece, which in turn induces a current in the inductance of the transmission line 240.

FIG. 8 is a schematic representation illustrating an electric field model of apparatus 200. The transmission line 240 of apparatus 200 is shown with the location of the induced electric field peaks represented by dotted lines 252. FIG. 8 schematically illustrates line inductance 244 and line capacitance 246 along with a parasitic capacitance 254 resulting from a dielectric piece in proximity to narrow conductor 218. At each electric field peak 252 of a standing wave created by RF signal source 228 high voltages are excited. A dielectric in close proximity to narrow conductor 218 at these locations behaves as a parasitic capacitance in parallel with the inductance of the transmission line 240.

FIG. 9 is a schematic representation of the electrical and magnetic fields generated around a test piece, such as cover 100, when being tested on apparatus 200. The signal supplied to apparatus 200 from RF source 228 generates standing waves along transmission line 240 of apparatus 200. The standing waves correspond to induced magnetic and electric fields generally represented by dotted lines 260. The peaks of the magnetic and/or electric fields may be used as indicators of the presence of metal or metallic concentrations in proximity to narrow conductor 218 of apparatus 200. The number and size of the peaks or nodes 262 may be varied by changing the frequency of the signal input to apparatus 200 with RF source 228. Changing the frequency of the signal input to apparatus 200 with RF source 228, permits testing a greater or lesser number of locations. Additionally, the peaks or nodes 262 will be located at different locations depending on the frequency. Thus, by changing the configuration of guides 210 and/or the frequency of the input signal, different parts having a different geometries and metallic loading may be tested with apparatus 200.

The plurality of magnetic field peaks 262, excited by the generated by signal RF source 228, electromagnetically couple any potential metallic content of cover 100 to narrow conductor 218. Variations in metallic content of cover 100 at one or more different locations of the cover, proximate to the multiple antenna positions adjacent to the cover, will create detectable deviations in a frequency loss response of transmission line 240 (FIG. 7). Detected deviations in the frequency loss response (FIGS. 11 and 12) may be analyzed to determine if the metallic content of the cover at locations corresponding to peaks 262 is great enough to interfere with the operation of the antenna. Since peaks 262 may be simultaneously generated at different locations, a plurality of different locations of the cover may be simultaneously tested for variations in the metallic content of cover 100.

A physical nonconformity of the shape of cover 100 may also be detected if the magnitude of the nonconformity is sufficient to affect the frequency loss response of transmission line 240. For example, cover 100 may be warped or twisted to a degree that the electromagnetic coupling of magnetic field peaks 262 with narrow conductor 218 is affected. If the effect is great enough, it will result in a detectable variation in the frequency response of transmission line 240. Any detected deviations in the frequency loss response (FIGS. 11 and 12) may be analyzed to determine if a physical nonconformity of the shape of cover 100 is great enough to interfere with the operation of the antenna.

FIG. 10 is a schematic representation of a system 300 for testing pieces such as cover 100 for metallic content. System 300 includes test apparatus 200 that may be positioned in a housing 302. As illustrated, test apparatus 200 is connected to a vector network analyzer 304 or similar RF source as previously described. As illustrated, vector network analyzer 304 includes a display 305 and an RF signal generator 307. Test apparatus 200 and/or vector network analyzer 304 may be interfaced with a computer 306 for monitoring and data collection purposes.

FIGS. 11 and 12 are graphical test results for parts tested using test apparatus 200. To determine the loading effect of a part such as cover 100 (FIG. 1) on an antenna system, the cover is placed in test apparatus 200 that is connected to vector network analyzer 304 (FIG. 10) and the return loss or S-11 parameter is measured. FIG. 11 illustrates an S-11 return loss curve 310 for an acceptable cover 100. As illustrated, the response curve fits within predetermined limits 312 established for acceptance of the part. Predetermined limits 312 may be determined with a reference part, e.g. cover, having an acceptable level of metal content in the cover at locations 104 (FIG. 3) and statistical analysis to determine an acceptable response range between limits 312. To test different parts with different physical configurations, or for parts having different tolerances to interference, different limits may be determined with a reference part and statistical analysis.

FIG. 12 illustrates a frequency response curve 314 for an unacceptable cover or part. As illustrated, response curve 314 falls outside of limits 312, indicating that the part or cover may interfere with antennas proximate to areas 104. In addition to detecting covers 100 having unacceptable levels of metallic content, test apparatus 200 may be utilized to identify physically non-conforming parts. For example, a cover that is warped, twisted, or otherwise dimensionally flawed beyond a predetermined amount may also interfere with the function of antennas adjacent areas 104 of cover 100. If the physical non-conformity of the cover is great enough to cause unacceptable antenna performance, apparatus 200 will also identify the cover as unacceptable.

FIG. 13 is a block diagram illustrating one method of testing a part such as cover 100 for out-of-specification metallic content or physical nonconformity. The process begins at 320 with test apparatus 200 being connected to vector network analyzer 304 (FIG. 10). Vector network analyzer 304 is set to preselected frequency to generate the desired standing wave, system 300 is calibrated to a reference and limits 312 (FIG. 11) set to a predetermined values established for acceptance of the part at step 322. The part to be tested is placed in test apparatus 200 at step 324 and vector network analyzer 304 is activated to transmit the selected RF frequency at 326. At step 328 the return loss (S-11) is measured and compared to predetermined limits 312. If the S-11 response for the part is within predetermined limits 312 at step 330, the part is accepted at step 332. Alternatively, if the S-11 response for the part is determined to be outside the predetermined limits at step 330, the part is discarded at step 334.

It will be appreciated by those skilled in the art having the benefit of this disclosure that this cover-testing fixture for radio frequency sensitive devices provides an economic and effective means of testing covers for devices such as cellular phones for metallic content. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. An apparatus for determining variations in the metallic content of a cover of a mobile communications device at a plurality of different locations corresponding to multiple antenna positions adjacent the cover, the apparatus comprising:
a radio frequency signal generator for generating a standing wave along a transmission line, the transmission line including a first conductor strip;
a first planar nonconductive substrate having a first side, the first conductor strip formed from a thin conductive film on, about and proximate to the perimeter of the first side of the first planar nonconductive substrate, the first conductor strip being connected at a first end to the radio frequency signal generator and configured to transmit a signal on a frequency corresponding to the standing wave, the signal exciting a plurality of magnetic field peaks extending along the first conductor strip and coinciding with a predetermined positioning of the cover at the plurality of different locations corresponding to the multiple antenna positions adjacent the cover;
the transmission line further comprising a second planar conductor formed from a thin metallic film substantially covering a first side of a second nonconductive planar substrate, the second nonconductive planar substrate and the second planar conductor being substantially parallel to the first conductor strip, the second conductor being electromagnetically coupled to the first conductor strip;
and wherein the plurality of magnetic field peaks, excited by the signal, are additionally configured to electromagnetically couple potential metallic content of the cover to the first conductor strip such that variations in metallic content of the cover at one or more different locations of the cover, proximate to the multiple antenna positions adjacent to the cover, create detectable deviations in a frequency loss response of the transmission line whereby the plurality of different locations of the cover are simultaneously tested for variations in the metallic content.

2. The apparatus of claim 1, wherein the number of the plurality of magnetic field peaks corresponding to the plurality of different locations may be varied to correspond with at least one different location by adjusting the frequency of the radio frequency signal generator whereby the at least one different location simultaneously tested for variations in metallic content.

3. The apparatus of claim 1, wherein the magnetic peaks couple or decouple with the cover's structure to detect physical nonconformities of a shape of the cover.

4. The apparatus of claim 3 wherein a physical nonconformity of the shape of the cover is a warp of the cover.

5. The apparatus of claim 1, further comprising at least one nonconductive guide member attached to the first planar nonconductive substrate and configured to retain the cover adjacent the second side of the first planar nonconductive substrate such that the cover is electromagnetically coupled to the first conductor strip when the first conductor strip is excited with the radio frequency signal source.

6. The apparatus of claim 1, wherein the first conductor strip is positioned to extend proximate to the periphery of the cover.

7. The apparatus of claim 1, wherein the first and second planar nonconductive substrates are interconnected with a plurality of spaced apart nonconductive connectors that maintain a predetermined distance between the first and second substrates.

8. The apparatus of claim 1, wherein the mobile communications device is a cellular phone and the potential metal content of the cover is in a coating that is a non-conductive vacuum metalized finish applied to an exterior surface of the cover.

9. A method for determining variations in the metallic content of a cover of a mobile communications device at a plurality of different locations corresponding to multiple antenna positions adjacent the cover, the method comprising:
configuring a radio frequency signal generator to generate a standing wave along a transmission line, the transmission line including a first conductor strip wherein the first conductor strip formed from a thin conductive film positioned on, about and proximate to the perimeter of a first side of a first planar nonconductive substrate and wherein the first conductor strip is connected at a first end to the radio frequency signal generator;
transmitting, with the signal generator, a signal on a frequency corresponding to the standing wave whereby the signal excites a plurality of magnetic field peaks along the first conductor strip coinciding with a predetermined positioning of the cover at the plurality of different locations that correspond to the multiple antenna positions;
wherein the transmission line further comprises a second planar conductor formed from a thin metallic film substantially covering a first side of a second nonconductive planar substrate, the second nonconductive planar substrate and the second planar conductor being substantially parallel to the first conductor strip, the second conductor being electromagnetically coupled to the first conductor strip;
whereby the plurality of magnetic field peaks, excited by the signal, electromagnetically couple potential metallic content of the cover to the first conductor strip such that variations in metallic content of the cover at one or more different locations of the cover, proximate to the multiple antenna positions adjacent to the cover, create detectable deviations in the return loss (S-11) response of the transmission line; and
identifying detectable deviations in the return loss (S-11) response of the transmission line as an indication of the metallic content of the cover at the one or more different locations on the cover.

10. The method of claim 9, further comprising varying the number of the plurality of magnetic field peaks corresponding to the plurality of different locations by adjusting the frequency of the radio frequency signal generator whereby the at least one different location simultaneously tested for variations in metallic content.

11. The method of claim 9 further comprising identifying detectable deviations in the return loss (S-11) response of the transmission line as an indication of one or more physical nonconformities of a shape of the cover.

12. The method of claim 11 wherein the physical nonconformity of the shape of the cover is a warp of the cover.

13. The method of claim 9, further comprising utilizing at least one nonconductive guide member attached to the first planar nonconductive substrate to retain the cover adjacent the second side of the first planar nonconductive substrate such that the cover is electromagnetically coupled to the first conductor strip when the first conductor strip is excited with the radio frequency signal source.

14. The method of claim 9, wherein the first conductor strip is positioned to extend proximate to the periphery of the cover.

15. The method of claim 9, wherein the first and second planar nonconductive substrates are interconnected with a plurality of spaced apart nonconductive connectors that maintain a predetermined distance between the first and second substrates.

16. The method of claim 9, wherein the mobile communications device is a cellular phone and the potential metal content of the cover is in a coating that is a non-conductive vacuum metalized finish applied to an exterior surface of the cover.

17. The method of claim 9, further comprising simultaneously identifying detectable deviations in the return loss (S-11) response of the transmission line as an indication of the metallic content of the cover at a plurality of different locations on the cover.

18. A system for determining variations in the metallic content of a cover of a mobile communications device at a plurality of different locations corresponding to multiple antenna positions adjacent the cover, the system including:
a test apparatus comprising:
a transmission line including a first conductor strip;
a first planar nonconductive substrate having a first side, the first conductor strip formed from a thin conductive film on, about and proximate to the perimeter of the first side of the first planar nonconductive substrate, the first conductor strip being connected at a first end to the radio frequency signal generator and configured to transmit a signal on a frequency corresponding to the standing wave, the signal exciting a plurality of magnetic field peaks extending along the first conductor strip and coinciding with a predetermined positioning of the cover at the plurality of different locations corresponding to the multiple antenna positions adjacent the cover;
the transmission line including a second planar conductor formed from a thin metallic film substantially covering a first side of a second nonconductive planar substrate, the second nonconductive planar substrate and the second planar conductor being substantially parallel to the first conductor strip, the second conductor being electromagnetically coupled to the first conductor strip; and
at least one nonconductive guide member attached to the first planar nonconductive substrate to retain the cover adjacent the second side of the first planar nonconductive substrate such that the cover is electromagnetically coupled to the first conductor strip when the first conductor strip is excited with the radio frequency signal source;
a radio frequency signal generator coupled to the first conductor for generating a standing wave along the transmission line;
a display, the display configured to show the return loss response of the transmission line; and
wherein the plurality of magnetic field peaks, excited by the signal, are additionally configured to electromagnetically couple potential metallic content of the cover to the first conductor strip such that variations in metallic content of the cover at one or more different locations of the cover, proximate to the multiple antenna positions adjacent to the cover, create detectable deviations in the return loss response.

19. The system of claim 18 wherein the number of the plurality of magnetic field peaks corresponding to the plurality of different locations may be varied to correspond with at least one different location by adjusting the frequency of the radio frequency signal generator whereby the at least one different location simultaneously tested for variations in metallic content.

20. The system of claim 18, wherein the mobile communications device is a cellular phone and the potential metal content of the cover is in a coating that is a non-conductive vacuum metalized finish applied to an exterior surface of the cover.
